(19) United States
(12) Patent Application Publication
(10) Pub. No.: US 2005/0289630 A1
(43) Pub. Date: Dec. 29, 2005

(54) Apparatus, method and system for self service digital media broadcast

(75) Inventors: Paul Andrews, Titusville, NJ (US); Jesse Lerman, Cranbury, NJ (US)

Correspondence Address: SYNNESTVEDT LECHNER & WOODBRIDGE LLP, P O BOX 592, PRINCETON, NJ, 08542-0592, US

(73) Assignee: Princeton Server Group, Princeton, NJ (US)

(21) Appl. No.: 11/149,728

(22) Filed: Jun. 10, 2005

Related U.S. Application Data
(60) Provisional application No. 60/578,791, filed on Jun. 10, 2004.

(51) Int. Cl. H04N 7/173; H04N 7/16

(52) U.S. Cl. 725/116; 725/117; 725/146; 725/147

(57) ABSTRACT

A method and apparatus to facilitate the automated management and broadcast of digital media content at a digital distribution facility, resulting in a hosted broadcast capability. The system includes an automated interface for scheduling the use of a digital media content distribution facility, including buying or selling of digital media broadcast capacity and satellite, terrestrial and cable-based digital content delivery services. The scheduling and sale may occur via a website that presents Content Originating Customers (COC) with a graphic representation of available broadcast capability, and allows the customer to interactively buy or bid for use of that capability.

### CROSS REFERENCE TO RELATED APPLICATIONS

This application is related to, and claims priority from, U.S. Provisional Patent application No. 60/578,791 filed on Jun. 10, 2004, by Paul Andrews, titled “Apparatus, Method and System for Self-service Digital Media Broadcast”, the entire contents of which are hereby incorporated by reference.

### FIELD OF THE INVENTION

The present invention relates to apparatus and methods for hosted broadcasting of digital media and, more particularly, to apparatus and methods that facilitate the automated buying, selling and provisioning of digital broadcast capability.

### BACKGROUND OF THE INVENTION

Satellite-based communications systems are well known ways of broadcasting electromagnetic communications signals to a large geographical area as described in, for instance, U.S. Pat. No. 6,726,152 issued to Higgins on Apr. 27, 2004, titled “Satellite Communications Systems” and U.S. Pat. No. 6,570,858 to Emmons, Jr., et al on May 27, 2003 titled Satellite-based communications system with terrestrial repeater and method therefore”, the contents of both of which are hereby incorporated by reference.

Operating a digital satellite, Advanced Television Systems Committee Television (ATSC TV) or cable-based digital media broadcast system requires special technical expertise, permits and licensing, long-term service commitments and a significant investment in broadcast facilities and transmission capacity. Due to high facilities costs, many broadcasters have found that it is more economical to share broadcast facilities than build their own. The technical and business complexity related to these shared facilities usually require that each participant (customer) in the sharing arrangement make a long-term business commitment. This long-term commitment and the high costs has limited the market for broadcast service to only the wealthiest businesses and media companies that have long term requirements. The long-term/high cost nature of this existing process has excluded a large group of potential broadcast services users. Broadcaster and capacity operators also lose potential revenue when large buyers order their transmission capacity and service in bulk and pay effectively wholesale rates. Smaller buyers would pay fees closer to retail rates.

Through the innovative use of technology and an understanding of the broadcast service market place, there is an opportunity to greatly expand the market for digital content distribution services over satellite, ATSC digital television and digital cable by first improving the efficiency the buying and selling process through automation and second providing a mechanism that promotes broadcast channels to viewers Reducing existing technical and cost related barriers to entry will stimulate a market for lower cost high value broadcasting business opportunities. These services include real-time and scheduled digital media (video and audio) broadcast, digital file delivery, real-time media streaming, store-and-forward streaming, real-time stream transcoding.

### SUMMARY OF THE INVENTION

Briefly described, the invention provides a method and apparatus to facilitate automated management and broadcast of digital media content at a digital distribution facility, resulting in a hosted broadcast capability. An objective of the invention is to provide an automated interface for scheduled use of a digital media content distribution facility. A further objective of the invention is lower adoption barriers, including price, related to selling digital media broadcast capacity and digital content delivery services via satellite, terrestrial and cable-based facilities.

In a preferred embodiment, a website presents Content Originating Customers (COC) with a graphic representation of available broadcast capability, and allows the customer to interactively buy or bid for use of that capability.

In a preferred embodiment, COC may then use the broadcast capability by means of store-and-play hardware and software.

In a further embodiment of the invention, the COC scheduled transmissions may be advertised on a website or transmitted to televisions via existing techniques such as ATSC Program and System Information Protocol (PSIP) or European Telecommunications Standard's (ETSI) Digital Video Broadcast (DVB-S SI) data channel. This may be done, for instance, as a real time, online Electronic Capacity Guide (ECG) in a form similar to an Electronic Program Guide (EPG).

These and other features of the invention will be more fully understood by references to the following drawings.

### BRIEF DESCRIPTION OF THE DRAWINGS

FIG. 1 is a schematic overview of a hosted broadcast system of a preferred embodiment of the present invention.

FIG. 2 is a schematic representation of a web page graphical user interface of an exemplary embodiment of the present invention.

FIG. 3 is a schematic representation of a further web page graphical user interface of an exemplary embodiment of the present invention.

FIG. 4 is a flow diagram showing representative steps of a content provider's interactions with an exemplary embodiment of the present invention.

FIG. 5 is a flow diagram showing representative steps of a content viewer's interactions with an exemplary embodiment of the present invention.

FIG. 6 is a flow diagram showing representative steps of a broadcast with an exemplary embodiment of the present invention.

FIG. 7 is a flow diagram showing representative steps of an advertiser's interaction with an exemplary embodiment of the present invention.

### DETAILED DESCRIPTION

The present invention relates to systems, technology and methods that dramatically lower adoption barriers and costs related to buying or selling digital media broadcast capacity and digital content delivery services via satellite, terrestrial and cable-based facilities.

Using specialized shared digital media server technology and unique business practices and systems, the present invention enables new and existing digital broadcasters to maximize use of transmission capacity, expand addressable markets, increase capacity demand and revenue.

Traditional broadcast digital media (content) distribution (satellite, terrestrial and cable) transmission has always been the providence of an exclusive club of owners and users. Digital media distribution is expensive; it requires special technical expertise, long-term service commitments and a significant investment in uplink/broadcast facilities and systems. The high cost of broadcast distribution has limited its use to only the wealthiest media companies. These media companies buy their transmission capacity in bulk and pay effectively wholesale rates to facilities operators.

There is an opportunity to expand demand for digital satellite content distribution services by eliminating long-term service commitments and up-front facilities investment. Reducing barriers to entry will stimulate a market for low cost narrow casting or micro casting services but at retail rates. These services include scheduled digital media (video and audio) broadcast, digital file delivery, real-time media streaming, store-and-forward streaming, real-time stream transcoding.

These and other aspects of the present invention will now be described in detail with reference to the accompanying drawings in which, as far as possible, like numbers represent like elements.

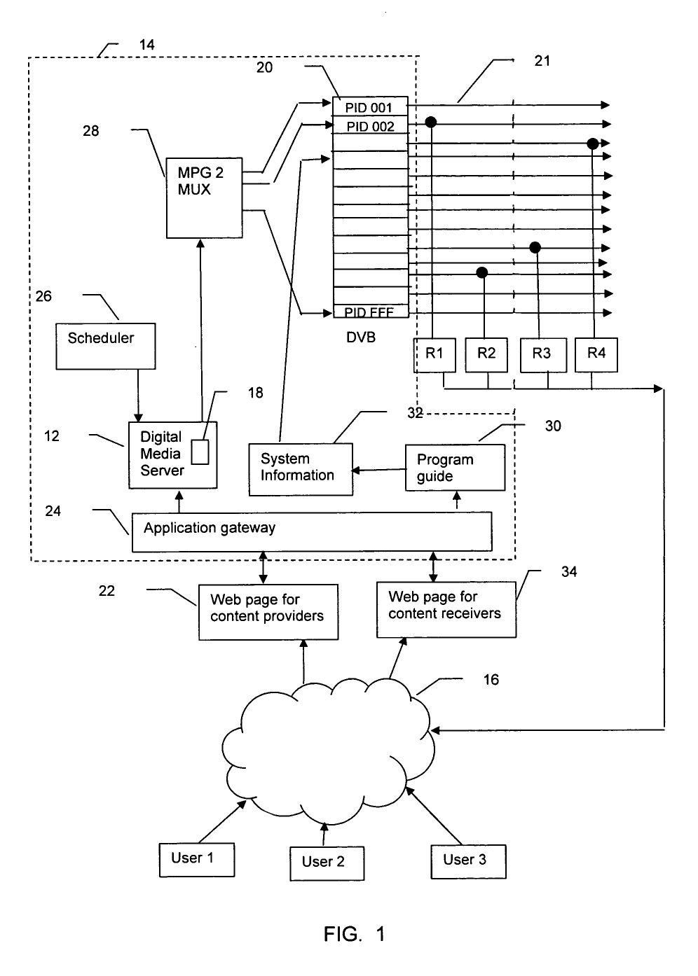

FIG. 1 is a schematic overview of a hosted broadcast system of a preferred embodiment of the present invention. In a preferred embodiment of the present invention, one or more content originating customers (COC) such as User 1, User 2 and User 3, are able to upload digital files 18 to a digital storage unit 12 at a host facility 14, via a terrestrial communications network 16. Once uploaded to the host facility 14, the digital files 18 may be broadcast via a digital broadcast stream 20 to one or more content receiving customers (CRC), such as R1, R2, R3 and R4.

The digital files 18 may be audio visual media files such as, but not limited to films, clips of films, television programs, audio files, advertising files, still images as well as data files such as, but not limited to, computer programs, game programs and databases. The terrestrial communications network 16 may be any suitable wired or wireless network including, but not limited to the Internet, the wired and wireless telephone networks and the cable network. The digital broadcast stream 20 may include any necessary components to handle digital packets, including appropriate radio frequency (RF) transmitters and receivers. In the event that the host facility is a satellite ground station and the digital broadcast stream 20 is a satellite digital broadcast stream, the transport stream will include any necessary satellite transponders to facilitate the transport of the packet data from the satellite ground station 14 to an orbiting satellite transponder for broadcast transmission to receivers such as those represented by R1, R2, R3 and R4.

In a preferred embodiment the content originating customer accesses a web page for content providers 22 which allows the selection of a broadcast time slot and facilitates the uploading of a file via an application gateway 24 to the digital storage unit 18 (also known as a digital media server).

In a preferred embodiment of the invention, at the appropriate time, a scheduler 26 accesses the appropriated digital file 18 stored in the digital storage unit and causes it to be transported to a suitable aggregating module such as, but not limited to, an MPG2 MUX 28. From the aggregating module 28, the digital file is fed to the satellite digital broad cast stream 20. In a typical digital broadcast stream the data is sent in packets having a header containing an identification, and a body containing the data. The packet identification (PID) is typically a number identifying a virtual channel that the data is associated with. For instance, a typical MPEG-2 packet consists of 188 bytes, of which 4 bytes are the header or PID and the remaining 188 bytes are the data. The 16 byte header allows over 8000 unique addresses to be assigned to the packets, each of which may be considered a virtual channel. Although the packets are typically transmitted serially in a 30 Mb/s data stream in a digital TV broadcast, they have been shown schematically in FIG. 1 as being transmitted along a channel associated with the unique broadcast PID.

Each digital television receiver then tunes to an appropriate channel by downloading the entire digital TV data stream and then filtering out the one or more channels desired by the end user by filtering out only the packets having the required broadcast PID's.

In a preferred embodiment of the invention the content receiving customers such as R1, R2, R3 and R4, may discover what content is being broadcast, or will be broadcast, in two distinct ways. A program guide 30 contains a database in which content descriptions associated with each of the files scheduled to be broadcast at each of the broadcast time slots on each of the channels associated with each of the unique broadcast PIDs.

This database of information in the program guide may be combined with general system information in the system information database before being broadcast on a particular channel, i.e. a stream of data having a particular PID. The content receiving customer may then receive this and other system data as a download on a particular channel. This data may be reviewed in, for instance, a standard interactive program guide.

Alternatively, the content receiving customer may access a web page for content receivers 34 that displays relevant data from the program guide 30. This access may be by, but is not limited to, a computer using the internet, a wireless telephone using a wireless network or a portable device using a WiFi connection or any suitable combination of such systems.

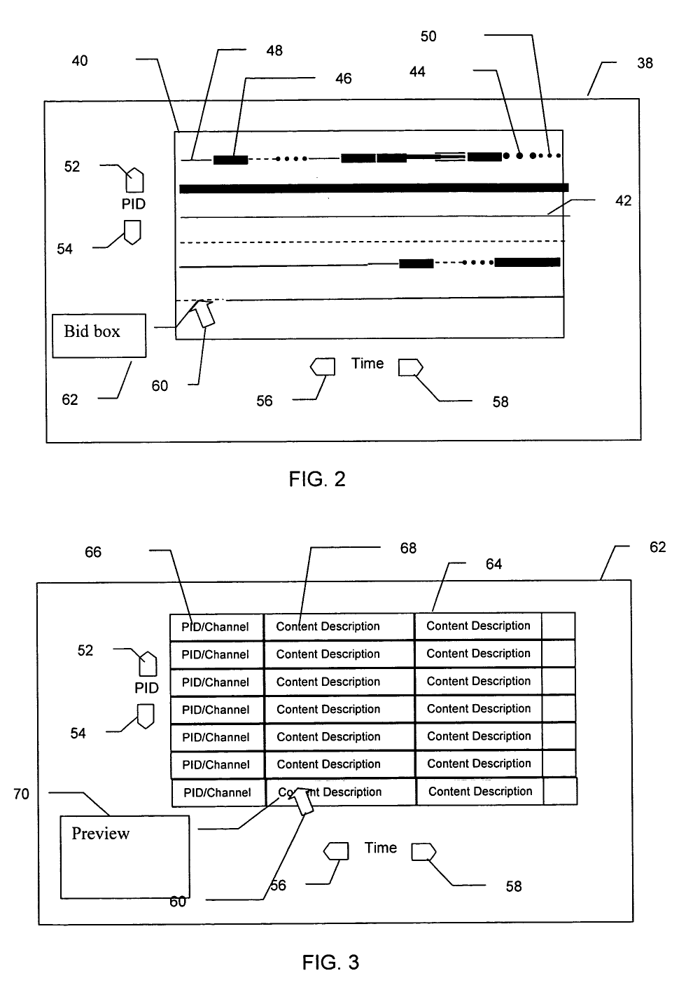

FIG. 2 is a schematic representation of a web page graphical user interface 38 of an exemplary embodiment of the present invention. In a preferred embodiment, the interface 38 includes a graphic display showing the availability of broadcast time slots 42 listed by PID number. Availability may, for instance be indicated by a dotted line 44 while already scheduled time may be indicated by a solid line 46. The width of the line may also indicate the bandwidth available on the line, so that a thin solid line 48 may indicate an already booked or scheduled low bandwidth broadcast time slot while the broad solid line 46 may indicate an already scheduled high bandwidth broadcast time slot. Similarly a thin dotted line 50 may indicate an available low bandwidth s broadcast time slot, while a thick dotted line 44 may indicate an available high bandwidth satellite broadcast time slot. Color schemes could be used with, or instead of, such schemes to indicate bandwidth or other attributes, including, but not limited to, whether advertisements will be allowed, whether pop up advertisements will be allowed and what type of content will be allowed.

The user may navigate through available channels or PIDs by using, for instance, an up arrow 52 or a down arrow 54. Similarly the user may navigate through available time by using, for instance, back arrow 56 or forward arrow 58.

The user may get further information about the details associated with a particular PID at a particular time by, for instance, positioning a curser 60 over the representation of the time slot associated with a particular PID at a particular time. A bid box 62 may pop up showing the user items such as, but not limited to, details of the channel availability such as bandwidth, a name associated with the channel, the type of content allowed on this time slot, such as X rated, or for family. The bid box may also allow the content providing customer to participate in an online auction for the time slot by submitting a bid. The bid box may also show the current state of an auction including, but not limited to, the current high bid and the time remaining on the auction. The bid may include factors other than price, including making advertising available to a third party, a range of acceptable broadcast bandwidths, and the type of content to be provided. The bid window may also provide a weighting formula showing the relative weighting or dollar equivalent of the additional features, including a single number, which may be a dollar equivalent, which is the number that need to be maximized to win the auction.

FIG. 3 is a schematic representation of a further web page graphical user interface 62 of an exemplary embodiment of the present invention. The user interface 62 includes a graphic display showing the associations of the stored digital files scheduled to be played and the broadcast times slots at which they are scheduled to be displayed. This may take the from of displaying the unique broadcast PID, channel identifier associated with them, alongside a bar showing a content description associated with the digital file due to be broadcast at that broadcast time slot on that channel. The content viewing customer may scroll through the available channels by, for instance, placing the cursor 60 over either the up arrow 52 or the down arrow 54. Similarly, the user may cause the display 64 to scroll backwards or forwards in time by placing the cursor 60 over the back button 56 or the forward button 58.

In a preferred embodiment, the user may see further details about content by placing the cursor 60 over the required content description 68, causing a preview window 70 to be displayed. The preview window 70 may have further details about the program, and may have options to play a preview of the content, which may be enlarged, or to set a reminder or a recording of the content to be made, or, if the content is currently being broadcast, to begin viewing the content.

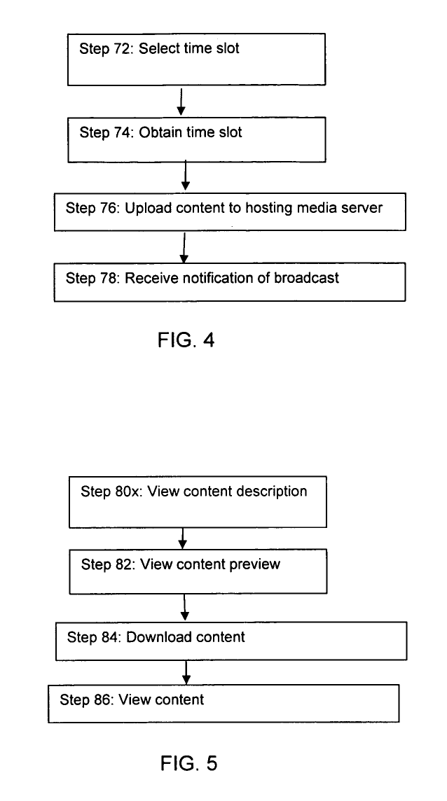

FIG. 4 is a flow diagram showing representative steps of a content provider's interactions with an exemplary embodiment of the present invention.

In step 72, the user selects a time slot. In a preferred embodiment, this may include viewing the web page of FIG. 2 to first determine if a suitable time slot is available. Once a suitable time slot is found, the user may obtain the time slot in step 74. Obtaining the time slot may entail entering an auction or otherwise purchasing the time slot using standard electronic transaction techniques such as, but not limited to, payment using a credit card on a secure site.

The auction or purchase options of step 72 may include, but are not limited to, a discount for specifying acceptable limits for transrating of the broadcast of the digital file such as predefined minimum and maximum bit rates, for allowing advertising, listing insertion points or times of allowed advertising and for allowing pop-up advertising. In the event that the user elects to allow pop-up advertising, they may also specify a pop-up percentage representing the maximum area of a screen that a pop-up may cover as well as the maximum number of pop-ups allowed and a maximum type for which each pop-up may be displayed.

Once the user has obtained and paid for the broadcast time slot they may then, in step 76, upload the content to be broadcast to the hosting media server. In a preferred embodiment, this may take the form of using a password, issued, for instance, to the user upon successfully obtaining the time slot in step 72. This password may allow the user to upload the digital file to be broadcast to the digital storage unit 12 at the ground station 14 via the application gateway 24, following instructions provided on the web page for content providers 22.

Once the content is uploaded to the digital media server, the content providing user does not have to do anything further. The scheduler 26 will automatically case the digital file to be loaded and broadcast by, for instance, streaming the file to an MPG2 MUX and then delivering it as a digital video broadcast to receivers R1, R2, R3 and R4. Once the file has been broadcast, the content providing user may receive notification of the broadcast having occurred in step 78. The notification of the broadcast having occurred may be in the form of an e-mail, a text-message, a voice-mail or any other suitable automatically generated message delivered to a suitable address or contact information supplied by the user. In a further embodiment of the invention, the user may also receive notifications prior to the broadcast reminding them that the broadcast is to occur and details of how to receive it, and the user may also receive notifications when the broadcast occurs.

FIG. 5 is a flow diagram showing representative steps of a content viewer's interactions with an exemplary embodiment of the present invention.

In step 80, the content receiving viewer view's the description of available content. This may by the content receiving user viewing a graphical display of the stored digital files and the broadcast time slots they are scheduled to be broadcast on, or are currently being broadcast on. This view may consist of a graphical display of a listing of unique broadcast PIDs, or a channel identifiers associated with the unique broadcast PIDs, showing a content description associated with the stored digital file as a function of the broadcast time slot.

In step 82 the content viewer may view more detailed information of a preview of the content to be broadcast. The preview may be delivered in real time as, for instance, a low quality streaming video over an internet connection, or it may be delivered as an attachment to an email.

In step 84 the content viewing user may tune into or download the content for viewing or use. In a preferred embodiment, this may consist of tuning a satellite receiver to a particular satellite or satellite digital video band so as to receive the digital broadcast transport stream being broadcast from the satellite ground station. Downloaded content may be stored for later use or viewing in step 86, or it may be viewed or listened to as it is downloaded.

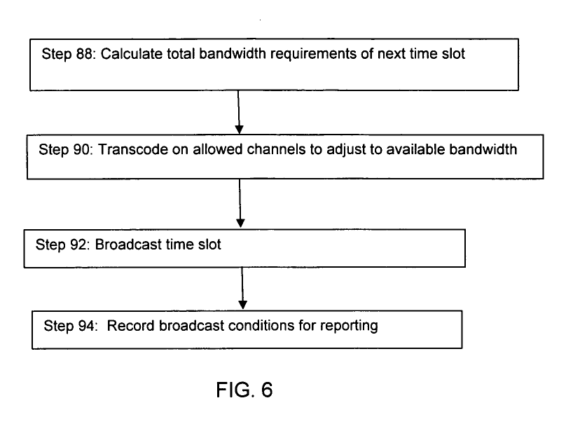

FIG. 6 is a flow diagram showing representative steps of a broadcast with an exemplary embodiment of the present invention.

In step 88, the scheduler 26 may calculate the total bandwidth requirements of the files scheduled to be broadcast in the next time slot. The scheduler may then compare the bandwidth requirement with the available bandwidth of the broadcast transport stream, and using the allowable, predetermined bandwidth rates associated with each digital file, proceed to transcode the digital files in step 90, or set the parameters for transrating the files as they are broadcast, so as to match the total bandwidth requirement to the total bandwidth available.

In step 92 the scheduler the causes the digital files to be broadcast, thereby creating the broadcast time slot.

In step 94 the scheduler may also record the broadcast conditions such as, but not limited to, the actual bit-rates at which the digital files are broadcast.

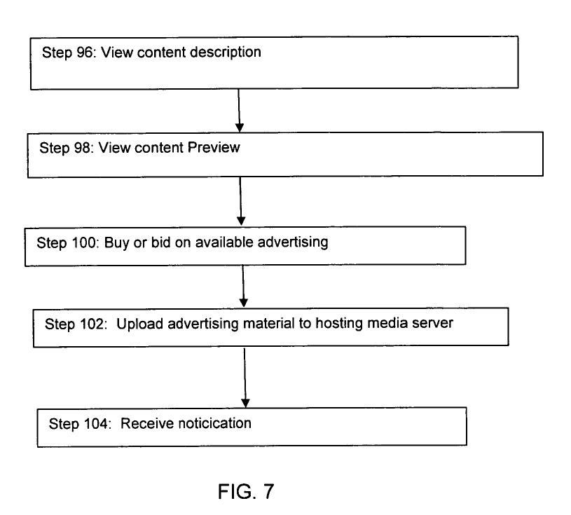

FIG. 7 is a flow diagram showing representative steps of an advertiser's interaction with an exemplary embodiment of the present invention.

In step 96 the advertiser views the content description by, for instance, logging on to the web page for content receivers 34 and viewing graphical user interface 38. In a preferred embodiment the web page 34 may have a further password protected section in which registered adverting account holders may see additional information not available to the general public. This additional information may take the form of more detailed information such as projected audience size and target or anticipated viewer demographics.

In step 98 the advertiser may preview the content. In a preferred embodiment, the registered advertiser may have access to additional preview material not available to the general public so as to be able to better access the impact of their advertising. This additional material may include additional material from the show, or it may include material in which they can interactively preview their advertising in selected sections of the content file.

In step 100 the advertiser may buy or bid for available interstitial advertising time slots or may buy or bid for available pop up advertising time. In a preferred embodiment of the invention this is accomplished by presenting registered advertisers, after suitable password or biometric authentication, with an additional pop up window, similar to the bid bode in FIG. 2. This bid box enables registered advertisers to see the amount and cost of currently available advertising within any time slot that is either being broadcast or will be broadcast. The bid window may also show the state and parameters of any on-line auction related to the available advertising and facilitate the registered advertisers participation including, but not limited to, bid submission and online payment.

In step 102 an advertiser who has successfully bought and paid for advertising, or obtained advertising by auction and paid for it, may then upload advertising material in the required format to the host media server. This uploading may, for instance, require passwords obtained at the time of payment and may, for instance, be facilitated by advertising wizards or other guidance software running on the application gateway.

Once the advertising has been broadcast, the advertiser may, in a preferred embodiment of the invention, then receive a notification of the broadcast. In further embodiments of the invention, the advertiser may also receive notifications on successfully uploading the advertising materials to the media server, and may receive reminder notifications about advertising scheduled to be broadcast and being broadcast.

In the preferred embodiment of the scheduling system may optimize bandwidth based on business rules such as maximizing the total revenue for a particular time slot by leveraging transrating or transcoding functions in the server. The server could perform the required transrating or transcoding on the digital files on-the-fly, i.e. as they are being streamed to the broadcast stream, or the transrating or transcoding may be performed in advance of the broadcast.

In a further embodiment of the invention, when the COC is contributing downloadable data files, they may specify a maximum download time, and a frequency of download opportunities when bidding for or buying hosted broadcast time.

In a further embodiment, advertisers may bid on available advertising and pop-up slots directly with the COG. The system may facilitate direct negotiation between COC and Advertiser that is offline to other advertisers.

In a further embodiment, the advertiser may also provide generic specifications to be used as a default in bids or buying, including information. The advertiser may also specify a block buy by specifying items such as, but not limited to, a frequency of required advertising, a category or rating of programs in which advertising is desired, a total advertising budget, a type of advertisement preferred and a time period over which the campaign is to run. One or more automated software agents may then automatically fulfill the advertiser's requirements by automatically buying the required amount and type of advertising online.

In further embodiments of the invention, the COC may enter other data fields when buying or bidding including, but not limited to the category for the broadcast, the type of broadcast including, but not limited to content for download or data, the content rating of the digital file to be broadcast, the type and number of advertising allowed during the advertising, where the advertising can be placed by time and location, whether transrating is allowed, the maximum budget per time period (in case of auto-bidding), ways to publish the broadcast including online guide, on screen guide, and RSS feeds, could even charge for assisting with promotion, i.e. the system may automatically buy a spot on Google Search, or in an online magazine, or in the TV guide as part of the contract.

The system and method described above are a broadcast hosting site to be set up in a way that makes business sense as seen by the following details that indicate that there is significant profit to be made in serving a retail satellite distribution market.

Wholesale Satellite Capacity
Transponder Lease=$160,000/mo.
Uplinking/Internet Access Fees=$40,000/mo.
Total Cost=$200,000/mo. or $4.63/min. for a 45 Mb/s satellite channel
Or $0.01 per minute for a 100 kb/s equivalent channel

Retail Model
45 Mb/s can be split into 450-100 kb/s channels
100 kb/s channels can be leased to users on a per minute basis
450 channels×30 days×24 hours×60 mins.=19440000 Channel mins.
19440000 mins.×$1.00 min.=$19M (max revenue)
Assume 10% average fill rate $19 M×0.10%=1.9 M/month revenue)
Wholesale Costs are $0.2M vs. Potential Retail Returns of $1.9M.

Self Service Concept is Key—

Using the Internet and dedicated terrestrial digital facilities as a highly scalable access technology; potential broadcast capacity customers are given the ability access and utilize digital broadcast transmission capacity on a self-service basis.

How it Works and How Customers Buy—

Content Originating Customers (COC) are customers that wish to purchase broadcast capacity and broadcast to a group of Content Receiving Customers (CRC).

COCs visit a specially designed website and browse blocks of unused satellite/DTV or cable transmission capacity by date, time and bandwidth. Each available block of capacity is represented graphically in a real-time on-line electronic capacity guide (ECG). This may for instance be accomplished in a form similar to an Electronic Program Guide (EPG) as described, for instance, in U.S. Pat. No. 6,728,967 issued to Bennington et al on Apr. 27, 2004, titled “Electronic television program guide schedule system and method”, the contents of which are hereby incorporated by reference. Pricing for transmission capacity can be based on various models such as: 1) Customer selects transmission start/stop time and amount of transmission capacity (bandwidth) required. Premium rates are charged for high demand time slots while off-peak capacity is offered at a discount. Bulk and full-period capacity purchases can be made by traditional contract. 2) Customers are permitted to bid on unutilized transmission capacity via an on-line auction mechanism. In all types of transactions, customers may pay on-line by credit card, by other electronic means at the time of purchase or by pre-arranged terms or billing. These transaction models may be incorporated into a website in a manner similar to, for instance, well known HTML technology as detailed in, for instance, U.S. Pat. No. 5,960,411 issued to Hartman et al. on Sep. 28, 1999, titled “Method and system for placing a purchase order via a communications network”, the contents of which are hereby incorporated by reference.

Transmission Capacity Access Technology—

COCs will be provided special hardware and/or software required to either transmit digital media content directly to broadcast transmission via pass-through or to various hosted digital broadcast applications located at the transmission facility. Hosted applications will permit COCs to transmit content to the digital broadcast facility via the Internet or point-to-point dedicated digital/analog transmission facilities, be stored and play-out on schedule or when capacity is available. Service applications will include: digital video and audio broadcast, streaming video and audio, linear and non-linear digital file delivery. COCs will be assigned a unique transmission channel ID that will identify the COCs traffic during the broadcast session.

Content Originating Customer (COC) Content Promotion—

After a COC buys a block of transmission capacity, they can submit content descriptions to a public or private “on-line” web-based electronic program guide. Customer content could be described as unencrypted (free-to-view) or encrypted and made available to receivers on a subscription or pay-per-view (PPV).

Content Receiving Customer (CRC)

Content Receiving Customers (CRCs) would be directed to an on-line web-based electronic program guide to browse for digital content offered by COCs. Content would be available for free-to-view (“vanity” or ad supported) or they could subscribe to an encrypted service. The digital transmission receiver equipment would be based on proprietary or non-proprietory technology (by others) and could be:

Purchased and installed by the COC for the use of the CRCs (network)

Service compatible equipment could be purchased by the CRC and used to receive content from various COCs.

The web site would also facilitate the sale and purchasing of hardware and software required to receive COC content.

Equipment Sales to Support COC/CRC Network Creation—

COC & CRC Customers can create virtual private networks. The business will act as an e-commerce clearinghouse linking customers to qualified equipment manufacturers and installers

In further embodiments of the invention, transmission capacity could displayed by cost, compression and whether or not real time transmission capability was necessary.

Transmission capacity may also be made available in a way that part of the available capacity is available by auction, part is reserved for purchase only after a certain date, such as one day prior to broadcast and part is available for spot or immediate purchase.

In a further embodiment, the content may be made available as “share ware”, in which the viewer only pays if they like the content or find it useful.

In a further embodiment, a Internet or telephone based link back to the broadcasters is also provided, enabling COC's to sell products or merchandise, similar to a “QVC for individuals”.

In a further embodiment, instantly, dynamically variable bandwith may be made available. For instance, if a broadcast channel was scheduled to nominally have 50% of its capacity available for non-real time applications (these are applications such as broadcasting data updates to sites, as done by for instance to chains of gas stations or convenience stores) and the remaining 50% for real time. During a broadcast a user may request or buy instant extra capacity. For instance, a COC customer may broadcast an image or video at low resolution or frame rate to advertise availability. If users find the image interesting, they may vote or pay the COC to increase the resolution or frame rate for better quality video, which the COC would provide by purchasing more bandwith on the instantly, dynamically available bandwidth.

Although the preferred embodiment shows a satellite digital broadcast stream, in further embodiments of the invention, the auction and storage concepts detailed above may be applied to video content distributed by any digital broadcast stream including, but not limited to, stream video broadcasts over the internet, video broadcasts over a terrestrial wireless network or broadcasts over a terrestrial cable network.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method of providing a hosted broadcast, comprising the steps of:
providing a host facility comprising at least one digital storage unit and at least one digital broadcast stream;
uploading at least one digital file to said host facility, from a site remote from said host facility, via a communications network;
storing said digital file, in its entirety, on said digital storage unit;
selecting, by a user remote from said host facility, a broadcast time slot;
associating said stored digital file with said selected broadcast time slot; and
broadcasting, subsequent to said step of storing, said at least one digital file via said at least one digital broadcast stream in said broadcast time slot, thereby providing said hosted broadcast.

2. The method of claim 1 wherein said host facility is a satellite ground station and wherein said digital broadcast stream is a satellite digital broadcast stream

3. The method of claim 1 further comprising auctioning, via an online auction, said provision of a hosted broadcast in said broadcast time slot.

4. The method of claim 3 wherein said step of auctioning further comprises specifying an amount of advertising time available for use by a hosted broadcast provider during said hosted broadcast.

5. The method of claim 4 wherein said step of auctioning further comprises specifying an amount of popup advertising time allowed in said hosted broadcast; and specifying a popup coverage percentage representing the maximum area of a screen that a pop-up advertisement may cover in said hosted broadcast.

6. The method of claim 3 wherein said step of auctioning further comprises specifying a predetermined range of bit-rates for said hosted broadcast, said range indicating a minimum acceptable bit rate for broadcast, and a maximum bit rate usable if spare bandwidth is available.

7. The method of claim 1 further including specifying a predetermined range of bit rates for said hosted broadcast, and wherein said step of broadcasting further comprises the step of transrating said broadcast of said at least one digital file so as to better match an available bandwidth of said digital broadcast stream for said digital file.

8. The method of claim 7 further including a step of optimizing said step of transrating to maximize the total revenue produced from said hosted broadcast.

9. The method of claim 7 further comprising the steps of encrypting said digital file; selling a decryption key to at least one content receiver; and varying said available bandwidth capacity for said digital file dependent on a number of said decryption keys sold.

10. The method of claim 9 wherein said step of varying said available bandwidth is dependent on a number of said decryption keys sold subsequent to a start time of said hosted satellite broadcast.

11. The method of claim 1 wherein said digital broadcast stream supports packets having a packet identification (PID); and further comprising selecting a unique broadcast PID, or a channel identifier associated with said unique broadcast PID, by said user remote from said broadcast host facility.

12. The method of claim 11 wherein said steps of selecting said broadcast time slot and selecting said unique broadcast PID, or said channel identifier associated with said unique broadcast PID, occur as transactions on a website.

13. The method of claim 12 wherein said website comprises a graphic display showing the availability of said broadcast time slots listed by said unique broadcast PIDs, or by said channel identifier.

14. The method of claim 1 further comprising the step of graphically displaying said associations of said stored digital file and said broadcast time slots on a website.

15. The method of claim 13, further comprising associating a unique broadcast PID, or a channel identifier associated with said unique broadcast PID, with said stored digital file; associating a content description with said stored digital file; graphically displaying said associated unique broadcast PID or said channel identifier on said website; and displaying said content description on said website.

16. An apparatus for providing a hosted broadcast, comprising:
a host facility comprising at a digital storage unit and least one digital broadcast stream;
at least one digital file, uploading to said host faculty from a site remote from said host facility via a terrestrial communications network and stored, in its entirety, on said digital storage unit;
a broadcast time slot, selected by a user remote from said host facility, associated with said stored digital file, specifying a time at which said at least one, stored, digital file is broadcast via said at least one digital broadcast stream, thereby providing said hosted broadcast.

17. The apparatus of claim 16 wherein said host facility is a satellite ground station and wherein said digital broadcast stream is a satellite digital broadcast stream

18. The apparatus of claim 16 further comprising an online auction, wherein bids for the provision of said hosted broadcast in said broadcast time slot comprises specifying an amount of advertising time available for use by a hosted broadcast provider during said hosted broadcast; specifying time slots in which advertisements may be displayed; specifying an amount of popup advertising time allowed in said hosted broadcast; and specifying a popup coverage percentage representing the maximum area of a screen that a pop-up advertisement may cover in said hosted broadcast.

19. The apparatus of claim 18 wherein said bids further comprises specifying a predetermined range of bit-rates for said hosted broadcast, said range indicating a minimum acceptable bit rate for broadcast, and a maximum bit rate usable if spare bandwidth is available.

20. A system for providing a hosted broadcast, comprising:
hosting means comprising means for storing a digital file, in its entirety, said digital file having been uploaded from a site remote from said host facility via a terrestrial communications network, and at least one means for providing digital broadcast stream; and
scheduling means for associating a broadcast time slot, selected by a user remote from said host facility, with said stored digital file, said broadcast time slot specifying a time at which said at least one, stored, digital file is broadcast via said at least one means for providing a digital broadcast stream, thereby providing said hosted broadcast.

21. The system of claim 20 wherein said hosting means is a satellite ground station and wherein said digital broadcast stream is a satellite digital broadcast stream

22. The system of claim 21 further comprising an online auction means for processing bids for the provision of said hosted broadcast in said broadcast time slot.

23. The system of claim 22 further comprising bid means for specifying an amount of advertising time available for use by a hosted broadcast provider during said hosted broadcast; bid means specifying an amount of popup advertising time allowed in said hosted broadcast; and bid means for specifying a popup coverage percentage representing the maximum area of a screen that a pop-up advertisement may cover in said hosted broadcast.

24. The system of claim 22 further comprising bid means for specifying a predetermined range of bit-rates for said hosted broadcast, said range indicating a minimum acceptable bit rate for broadcast, and a maximum bit rate usable if spare bandwidth is available.
